(19) United States
(12) Patent Application Publication
(10) Pub. No.: US 2018/0188502 A1
(43) Pub. Date: Jul. 5, 2018

(54) PANORAMA IMAGE CAPTURING DEVICE HAVING AT LEAST TWO CAMERA LENSES AND PANORAMA IMAGE CAPTURING MODULE THEREOF

(71) Applicant: Prolific Technology Inc., Tapei (TW)

(72) Inventors: CHING-TE SHIH, KAOHSIUNG CITY (TW); GUAN-YU CHEN, Hsinchu City (TW); CHI-FANG MA, Taipei City (TW); CHIUN-SHIU CHEN, Hsinchu City (TW); HSIN-YUEH CHANG, Hsinchu County (TW)

(21) Appl. No.: 15/862,731

(22) Filed: Jan. 5, 2018

Related U.S. Application Data
(60) Provisional application No. 62/442,678, filed on Jan. 5, 2017.

(51) Int. Cl. G02B 13/06; H04N 5/232; G03B 37/04

(52) U.S. Cl. CPC G02B 13/06; G03B 37/04; H04N 5/23238

(57) ABSTRACT

The present invention provides a panorama image capturing device and a panorama image capturing module thereof. The panorama image capturing module includes a lens structure, an optical structure, a single image sensing chip, and a single image signal processor. The lens structure includes a first lens assembly for capturing a first predetermined image light source, and a second lens assembly for capturing a second predetermined image light source. The optical structure is disposed between the first lens assembly and the second lens assembly. The single image sensing chip has a first image sensing region for receiving the first predetermined image light source through the optical structure, and a second image sensing region for receiving the second predetermined image light source through the optical structure. The first and the second predetermined image light sources are processed by the single image signal processor for obtaining a panorama image.

### CROSS REFERENCE TO RELATED APPLICATION

This application claims priority to U.S. Provisional Patent Application Ser. No. 62/442,678, filed on Jan. 5, 2017, the entire disclosure of which is hereby expressly incorporated by reference herein.

### FIELD OF THE INVENTION

The present disclosure relates to a panorama image capturing device and a panorama image capturing module thereof, and more particularly to a panorama image capturing device having at least two camera lenses and a panorama image capturing module thereof.

### BACKGROUND OF THE INVENTION

Panoramic photography is a style of photography that aims to create images with exceptionally wide fields of view. Normally, a panoramic image is made by successively capturing multiple photographs and then stitching these photographs together as a larger-sized panoramic image.

### SUMMARY OF THE INVENTION

One aspect of the present disclosure relates to a panorama image capturing device having at least two camera lenses and a panorama image capturing module thereof.

One of the embodiments of the present disclosure provides a panorama image capturing module having at least two camera lenses, comprising a lens structure, an optical structure, a single image sensing chip, and a single image signal processor. The lens structure includes a first lens assembly for capturing a first predetermined image light source, and a second lens assembly for capturing a second predetermined image light source. The optical structure is disposed between the first lens assembly and the second lens assembly. The single image sensing chip is adjacent to the optical structure, and the single image sensing chip has a first image sensing region and a second image sensing region. The single image signal processor is electrically connected to the single image sensing chip. More particularly, the first predetermined image light source is projected onto the first image sensing region through the optical structure, and the first predetermined image light source is captured by the first image sensing region for obtaining a first image signal. The second predetermined image light source is projected onto the second image sensing region through the optical structure, and the second predetermined image light source is captured by the second image sensing region for obtaining a second image signal. The first image signal and the second image signal are combined into a single raw image signal. The single raw image signal is transmitted to the single image signal processor, and the single raw image signal is processed by the single image signal processor for obtaining a panorama image.

Another one of the embodiments of the present disclosure provides a panorama image capturing module having at least two camera lenses, comprising a lens structure, an optical structure, a single image sensing chip, and a single image signal processor. The lens structure includes a first lens assembly for capturing a first predetermined image light source, and a second lens assembly for capturing a second predetermined image light source. The optical structure is disposed between the first lens assembly and the second lens assembly. The single image sensing chip is adjacent to the optical structure. The single image sensing chip has a first image sensing region for receiving the first predetermined image light source through the optical structure, and a second image sensing region for receiving the second predetermined image light source through the optical structure. The single image signal processor is electrically connected to the single image sensing chip, and both the first predetermined image light source and the second predetermined image light source are processed by the single image signal processor for obtaining a panorama image.

Yet another one of the embodiments of the present disclosure provides a panorama image capturing device having at least two camera lenses, comprising an outer casing and a panorama image capturing module. The outer casing has a first light-transmitting window and a second light-transmitting window. The panorama image capturing module is disposed inside the outer casing, and the panorama image capturing module comprises a lens structure, an optical structure, a single image sensing chip, and a single image signal processor. The lens structure includes a first lens assembly for capturing a first predetermined image light source through the first light-transmitting window, and a second lens assembly for capturing a second predetermined image light source through the second light-transmitting window. The optical structure is disposed between the first lens assembly and the second lens assembly. The single image sensing chip is adjacent to the optical structure. The single image sensing chip has a first image sensing region for receiving the first predetermined image light source through the optical structure, and a second image sensing region for receiving the second predetermined image light source through the optical structure. The single image signal processor is electrically connected to the single image sensing chip, and both the first predetermined image light source and the second predetermined image light source are processed by the single image signal processor for obtaining a panorama image.

Therefore, by matching the features of “the single image sensing chip having a first image sensing region for receiving the first predetermined image light source through the optical structure, and a second image sensing region for receiving the second predetermined image light source through the optical structure” and “the single image signal processor being electrically connected to the single image sensing chip”, both the first predetermined image light source and the second predetermined image light source can be processed by the single image signal processor for obtaining a panorama image.

To further understand the techniques, means and effects of the present disclosure, the following detailed descriptions and appended drawings are hereby referred to, such that, and through which, the purposes, features and aspects of the present disclosure can be thoroughly and concretely appreciated. However, the appended drawings are provided solely for reference and illustration, without any intention to limit the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a lateral schematic view of a panorama image capturing module according to the first embodiment of the present disclosure;

FIG. 2 shows a top schematic view of a single image sensing chip of the panorama image capturing module according to the first embodiment of the present disclosure;

FIG. 3 shows a lateral schematic view of the panorama image capturing module according to the second embodiment of the present disclosure;

FIG. 4 shows a top schematic view of the panorama image capturing module according to the third embodiment of the present disclosure;

FIG. 5 shows a top schematic view of a single image sensing chip of the panorama image capturing module according to the third embodiment of the present disclosure;

FIG. 6 shows a lateral schematic view of a first lens assembly, a first reflective mirror, and a first image sensing region of the panorama image capturing module according to the third embodiment of the present disclosure;

FIG. 7 shows a lateral schematic view of a second lens assembly, a second reflective mirror, and a second image sensing region of the panorama image capturing module according to the third embodiment of the present disclosure;

FIG. 8 shows a top schematic view of another single image sensing chip of the panorama image capturing module according to the third embodiment of the present disclosure;

FIG. 9 shows a top schematic view of the panorama image capturing module according to the fourth embodiment of the present disclosure;

FIG. 10 shows a lateral schematic view of a first lens assembly, a first reflective mirror, and a first image sensing region of the panorama image capturing module according to the fourth embodiment of the present disclosure;

FIG. 11 shows a lateral schematic view of a second lens assembly, a second reflective mirror, and a second image sensing region of the panorama image capturing module according to the fourth embodiment of the present disclosure;

FIG. 12 shows a lateral schematic view of a single image sensing chip and a single image signal processor mated with each other according to the fifth embodiment of the present disclosure;

FIG. 13 shows a schematic view of a panorama image capturing device according to the sixth embodiment of the present disclosure;

FIG. 14 shows a lateral schematic view of a panorama image capturing module according to the seventh embodiment of the present disclosure;

FIG. 15 shows a top schematic view of a single image sensing chip of the panorama image capturing module according to the seventh embodiment of the present disclosure;

FIG. 16 shows a lateral schematic view of the panorama image capturing module according to the eighth embodiment of the present disclosure;

FIG. 17 shows a top schematic view of a single image sensing chip of the panorama image capturing module according to the eighth embodiment of the present disclosure;

FIG. 18 shows a lateral schematic view of a first lens assembly, a light consolidating prism and a first image sensing region of the panorama image capturing module according to the eighth embodiment of the present disclosure;

FIG. 19 shows a lateral schematic view of a second lens assembly, a light consolidating prism and a second image sensing region of the panorama image capturing module according to the eighth embodiment of the present disclosure;

FIG. 20 shows a lateral schematic view of a third lens assembly, a light consolidating prism and a third image sensing region of the panorama image capturing module according to the eighth embodiment of the present disclosure;

FIG. 21 shows a top schematic view of another single image sensing chip of the panorama image capturing module according to the eighth embodiment of the present disclosure;

FIG. 22 shows a lateral schematic view of a single image sensing chip and a single image signal processor matched with each other according to the ninth embodiment of the present disclosure; and

FIG. 23 shows a schematic view of a panorama image capturing device according to the tenth embodiment of the present disclosure.

### DETAILED DESCRIPTION OF THE PREFERRED EMBODIMENTS

Embodiments of a panorama image capturing device having at least two camera lenses and a panorama image capturing module thereof according to the present disclosure are described herein. Other advantages and objectives of the present disclosure can be easily understood by one skilled in the art from the disclosure. The present disclosure can be applied in different embodiments. Various modifications and variations can be made to various details in the description for different applications without departing from the scope of the present disclosure. The drawings of the present disclosure are provided only for simple illustrations, but are not drawn to scale and do not reflect the actual relative dimensions. The following embodiments are provided to describe in detail the concept of the present disclosure, and are not intended to limit the scope thereof in any way.

### First Embodiment

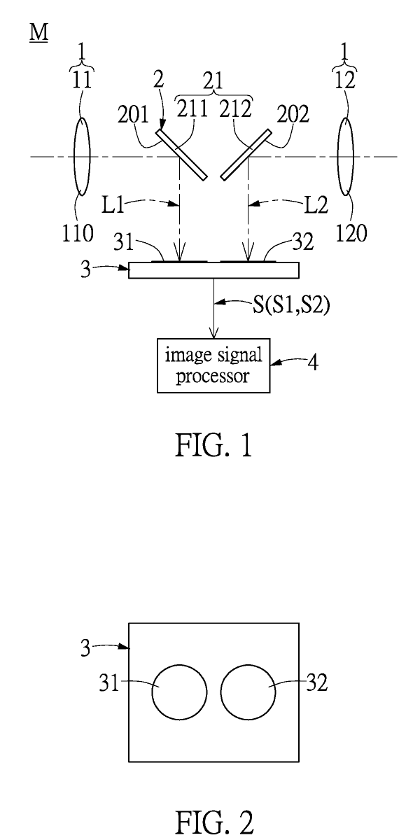

Referring to FIG. 1 to FIG. 2, the first embodiment of the present disclosure provides a panorama image capturing module M having at least two camera lenses, comprising a lens structure 1, an optical structure 2, a single image sensing chip 3, and a single image signal processor 4.

First, referring to FIG. 1 and FIG. 2, the lens structure 1 includes a first lens assembly 11 for capturing a first predetermined image light source L1, and a second lens assembly 12 for capturing a second predetermined image light source L2. For example, as shown in FIG. 1, the first lens assembly 11 and the second lens assembly 12 correspond to each other, that is to say, the first lens assembly 11 and the second lens assembly 12 are not staggered with respect to each other. In addition, as shown in FIG. 1, the first lens assembly 11 may be composed of one or more first lenses 110, and the second lens assembly 12 may be composed of one or more first lenses 120. It should be noted that the first lens assembly 11 is composed of the first lens 110, and the second lens assembly 12 is composed of the second lenses 120 as shown in FIG. 1, but it is merely an example and is not meant to limit the scope of the present disclosure.

Moreover, as shown in FIG. 1, the optical structure 2 is disposed between the first lens assembly 11 and the second lens assembly 12. For example, the optical structure 2 has a first reflective surface 201 and a second reflective surface 202 corresponding to each other, that is to say, the first reflective surface 201 and the second reflective surface 202 are not staggered with respect to each other. In addition, the optical structure 2 is one of a prism and a reflective mirror assembly 21. For example, when the optical structure 2 is the reflective mirror assembly 21, both the first reflective surface 201 and the second reflective surface 202 are respectively disposed on an outer surface of a first reflective mirror 211 and an outer surface of a second reflective mirror 212 of the reflective mirror assembly 21.

Furthermore, referring to FIG. 1 and FIG. 2, the single image sensing chip 3 is adjacent to the optical structure 2, and the single image sensing chip 3 has a first image sensing region 31 and a second image sensing region 32. More particularly, the first predetermined image light source L1 can be projected onto the first image sensing region 31 through the optical structure 2, and the second predetermined image light source L2 can be projected onto the second image sensing region 32 through the optical structure 2. That is to say, the single image sensing chip 3 has a first image sensing region 31 for receiving the first predetermined image light source L1 through the optical structure 2, and a second image sensing region 32 for receiving the second predetermined image light source L2 through the optical structure 2. In addition, the first predetermined image light source L1 can be captured by the first image sensing region 31 for obtaining a first image signal S1, and the second predetermined image light source L2 can be captured by the second image sensing region 32 for obtaining a second image signal S2. It should be noted that the first image signal S1 and the second image signal S2 can be combined into a single raw image signal S. That is to say, when the first predetermined image light source L1 and the second predetermined image light source L2 are respectively captured by the first image sensing region 31 and the second image sensing region 32 of the single image sensing chip 3, the single image sensing chip 3 can be used to directly generate a single raw image signal

S.

For example, referring to FIG. 1 and FIG. 2, the single image sensing chip 3 can be disposed on a circuit substrate (not shown) and electrically connected to a CMOS chip or any light sensor chip in advance. In addition, the first image sensing region 31 and the second image sensing region 32 correspond to each other, that is to say, the first image sensing region 31 and the second image sensing region 32 are not staggered with respect to each other. Moreover, the first predetermined image light source L1 can be reflected by the first reflective surface 201 of the optical structure 2 and then is projected onto the first image sensing region 31, and the second predetermined image light source L2 can be reflected by the second reflective surface 202 of the optical structure 2 and then is projected onto the second image sensing region 32.

It should be noted that the area of the first image sensing region 31 and the area of the second image sensing region 32 are substantially the same or different. When the area of the first image sensing region 31 is greater than the area of the second image sensing region 32, the first image sensing region 31 can be used as a main image sensing area, and the second image sensing region 32 can be used as an auxiliary image sensing area.

It should be noted that the image resolution of the first image sensing region 31 and the image resolution of the second image sensing region 32 are substantially the same or different. When the image resolution of the first image sensing region 31 is greater than the image resolution of the second image sensing region 32, the first image sensing region 31 can be used as a main image sensing area, and the second image sensing region 32 can be used as an auxiliary image sensing area.

In addition, as shown in FIG. 1, the single image signal processor 4 is electrically connected to the single image sensing chip 3. More particularly, the single raw image signal S that includes the first image signal S1 and the second image signal S2 can be transmitted to the single image signal processor 4, and then the single raw image signal S that includes the first image signal S1 and the second image signal S2 can be processed by the single image signal processor 4 for obtaining a panorama image. That is to say, both the first predetermined image light source L1 and the second predetermined image light source L2 can be processed by the single image signal processor 4 for obtaining a panorama image. It should be noted that the panorama image can be replaced by a panorama video, and the panorama may be a broad panorama, a 360° panorama, or a spherical panorama.

It should be noted that the first lens assembly 11 and the second lens assembly 12 correspond to each other, the first reflective surface 201 and the second reflective surface 202 of the optical structure 2 correspond to each other, and the first image sensing region 31 and the second image sensing region 32 correspond to each other, so that an optical path of the first predetermined image light source L1 and an optical path of the second predetermined image light source L2 correspond to each other, that is to say, the optical path of the first predetermined image light source L1 and the optical path of the second predetermined image light source L2 are not staggered with respect to each other.

Therefore, the panorama image capturing module M can use the single image sensing chip 3 to capture the first predetermined image light source L1 and the second predetermined image light source L2, and the panorama image capturing module M can use the single image signal processor 4 to process the first predetermined image light source L1 and the second predetermined image light source L2 so as to obtain a panorama image, so that the cost of manufacturing the panorama image capturing module M can be decreased.

### Second Embodiment

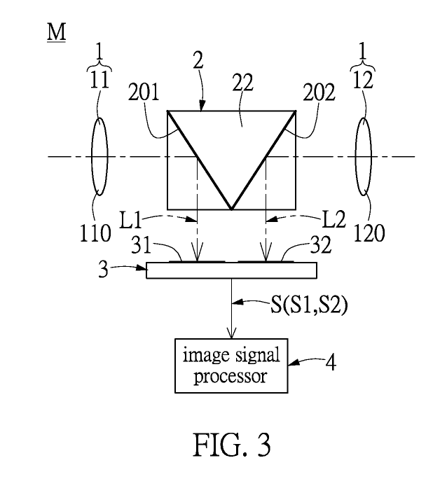

Referring to FIG. 3, the second embodiment of the present disclosure provides a panorama image capturing module M having at least two camera lenses, comprising a lens structure 1, an optical structure 2, a single image sensing chip 3, and a single image signal processor 4. Comparing FIG. 3 with FIG. 1, the difference between the second embodiment and the first embodiment is as follows: in the second embodiment, the optical structure 2 may be a prism 22, and both the first reflective surface 201 and the second reflective surface 202 are disposed inside the prism 22.

Therefore, the first predetermined image light source L1 can be projected onto the first image sensing region 31 through the optical structure 2, and the first predetermined image light source L1 can be captured by the first image sensing region 31 for obtaining a first image signal S1. In addition, the second predetermined image light source L2 can be projected onto the second image sensing region 32 through the optical structure 2, and the second predetermined image light source L2 can be captured by the second image sensing region 32 for obtaining a second image signal S2. Then, the first image signal S1 and the second image signal S2 can be combined into a single raw image signal S. Finally, the single raw image signal S that includes the first image signal S1 and the second image signal S2 can be transmitted to the single image signal processor 4, and then the single raw image signal S that includes the first image signal S1 and the second image signal S2 can be processed by the single image signal processor 4 for obtaining a panorama image.

### Third Embodiment

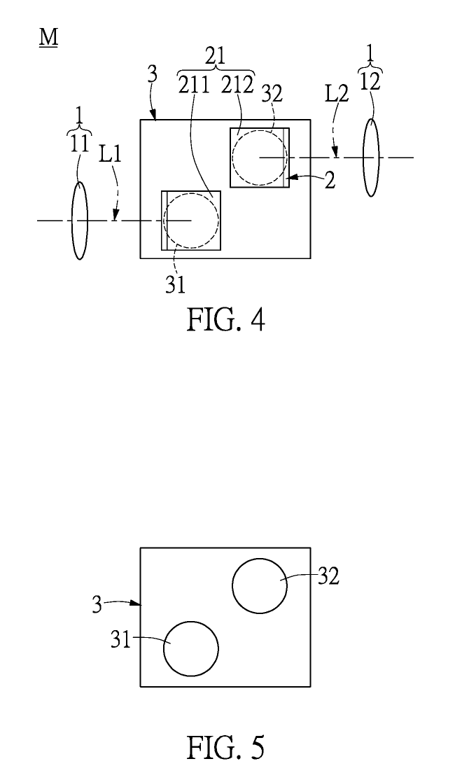

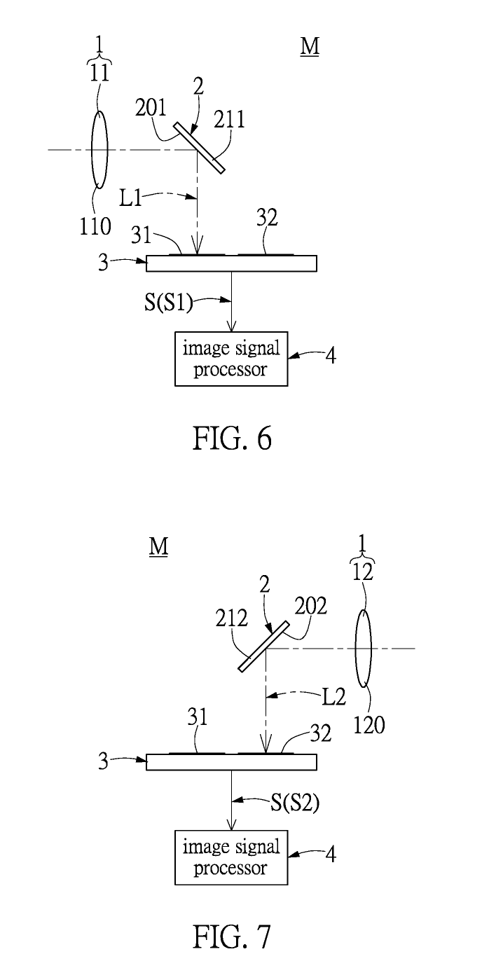

Referring to FIG. 4 to FIG. 7, the third embodiment of the present disclosure provides a panorama image capturing module M having at least two camera lenses, comprising a lens structure 1, an optical structure 2, a single image sensing chip 3, and a single image signal processor 4. Comparing FIG. 4 (including FIG. 6 and FIG. 7) with FIG. 1, the difference between the third embodiment and the first embodiment is as follows: in the third embodiment, the first lens assembly 11 and the second lens assembly 12 are staggered with respect to each other relative to a horizontal baseline (not shown) as shown in FIG. 4, the optical structure 2 has a first reflective surface 201 (as shown in FIG. 6) and a second reflective surface 202 (as shown in FIG. 7) staggered with respect to each other, and the first image sensing region 31 and the second image sensing region 32 are staggered with respect to each other (as shown in FIG. 5). Hence, an optical path of the first predetermined image light source L1 and an optical path of the second predetermined image light source L2 are staggered with respect to each other.

For example, referring to FIG. 1, FIG. 6 and FIG. 7, the optical structure 2 is the reflective mirror assembly 21, and both the first reflective surface 201 and the second reflective surface 202 are respectively disposed on an outer surface of a first reflective mirror 211 and an outer surface of a second reflective mirror 212 of the reflective mirror assembly 21.

Therefore, the first predetermined image light source L1 can be projected onto the first image sensing region 31 through the optical structure 2, and the first predetermined image light source L1 can be captured by the first image sensing region 31 for obtaining a first image signal S1. In addition, the second predetermined image light source L2 can be projected onto the second image sensing region 32 through the optical structure 2, and the second predetermined image light source L2 can be captured by the second image sensing region 32 for obtaining a second image signal S2. Then, the first image signal S1 and the second image signal S2 can be combined into a single raw image signal S. Finally, the single raw image signal S that includes the first image signal S1 and the second image signal S2 can be transmitted to the single image signal processor 4, and then the single raw image signal S that includes the first image signal S1 and the second image signal S2 can be processed by the single image signal processor 4 for obtaining a panorama image.

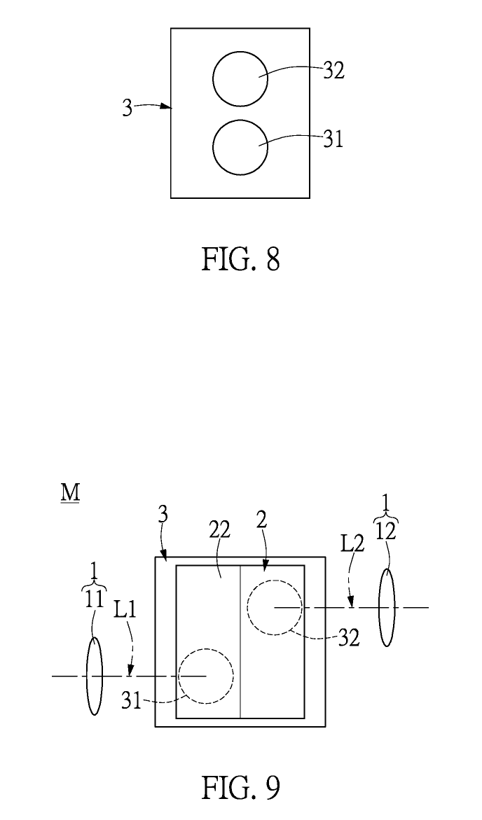

It should be noted that the first image sensing region 31 and the second image sensing region 32 are staggered with respect to each other relative to a horizontal baseline (not shown) as shown in FIG. 8. That is to say, the staggered arrangement of the first image sensing region 31 and the second image sensing region 32 can be changed according to different requirements. For example, the first image sensing region 31 and the second image sensing region 32 can be staggered with respect to each other along X direction and Y direction as shown in FIG. 5, or the first image sensing region 31 and the second image sensing region 32 can be staggered with respect to each other along X direction or Y direction as shown in FIG. 8.

### Fourth Embodiment

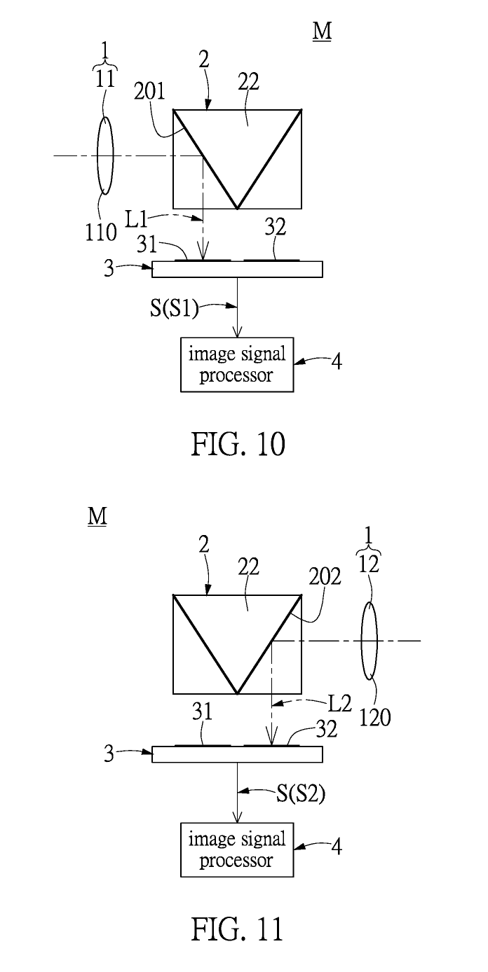

Referring to FIG. 9 to FIG. 11, the fourth embodiment of the present disclosure provides a panorama image capturing module M having at least two camera lenses, comprising a lens structure 1, an optical structure 2, a single image sensing chip 3, and a single image signal processor 4. Comparing FIG. 9 with FIG. 4, FIG. 10 with FIG. 6, and FIG. 11 with FIG. 7, the difference between the fourth embodiment and the third embodiment is as follows: in the fourth embodiment, the optical structure 2 may be a prism 22, and both the first reflective surface 201 and the second reflective surface 202 are disposed inside the prism 22.

Therefore, the first predetermined image light source L1 can be projected onto the first image sensing region 31 through the optical structure 2, and the first predetermined image light source L1 can be captured by the first image sensing region 31 for obtaining a first image signal S1. In addition, the second predetermined image light source L2 can be projected onto the second image sensing region 32 through the optical structure 2, and the second predetermined image light source L2 can be captured by the second image sensing region 32 for obtaining a second image signal S2. Then, the first image signal S1 and the second image signal S2 can be combined into a single raw image signal S. Finally, the single raw image signal S that includes the first image signal S1 and the second image signal S2 can be transmitted to the single image signal processor 4, and then the single raw image signal S that includes the first image signal S1 and the second image signal S2 can be processed by the single image signal processor 4 for obtaining a panorama image.

### Fifth Embodiment

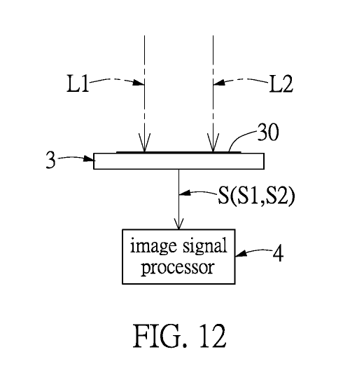

Referring to FIG. 12, the fifth embodiment of the present disclosure provides a single image sensing chip 3 and a single image signal processor 4, and the single image sensing chip 3 has a single image sensing region 30. That is to say, the first image sensing region 31 and the second image sensing region 32 of any one of the first to the fourth embodiments can be connected with each other to form a single image sensing region 30.

Therefore, the single image sensing chip 3 can be used by matching the first image sensing region 31 and the second image sensing region 32 (as shown in the first to the fourth embodiments), or can be used by only using the single image sensing region 30 (as shown in the fifth embodiment).

### Sixth Embodiment

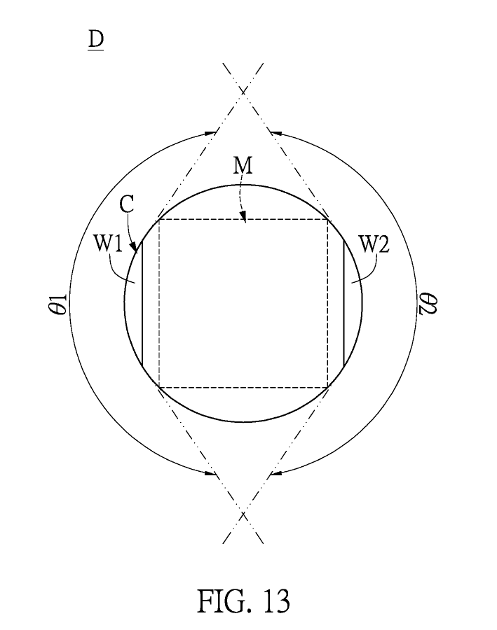

Referring to FIG. 13, the sixth embodiment of the present disclosure provides a panorama image capturing device D having at least two camera lenses, comprising an outer casing C and a panorama image capturing module M. The panorama image capturing device D as shown in FIG. 13 can use the panorama image capturing module M of any one of the first to the fourth embodiments.

For example, referring to FIG. 1 to FIG. 13, the panorama image capturing device D as shown in FIG. 13 can use the panorama image capturing module M of the first embodiment. More particularly, the outer casing C has a first light-transmitting window W1 (such as a first transparent cover) and a second light-transmitting window W2 (such as a second transparent cover). The panorama image capturing module M is disposed inside the outer casing C, and the panorama image capturing module M comprises a lens structure 1, an optical structure 2, a single image sensing chip 3, and a single image signal processor 4.

As described above, the lens structure 1 includes a first lens assembly 11 for capturing a first predetermined image light source L1 through the first light-transmitting window W1, and a second lens assembly 12 for capturing a second predetermined image light source L2 through the second light-transmitting window W2. That is to say, the first lens assembly 11 can be used to capture a first predetermined image light source L1 by a first predetermined wide-angle θ1 greater than 180° through the first light-transmitting window W1, and the second lens assembly 12 can be used to capture a second predetermined image light source L2 by a second predetermined wide-angle θ2 greater than 180° through the second light-transmitting window W2.

As described above, the optical structure 2 is disposed between the first lens assembly 11 and the second lens assembly 12. In addition, the single image sensing chip 3 is adjacent to the optical structure 2, and the single image sensing chip 3 has a first image sensing region 31 for receiving the first predetermined image light source L1 through the optical structure 2, and a second image sensing region 32 for receiving the second predetermined image light source L2 through the optical structure 2. Moreover, the single image signal processor 4 is electrically connected to the single image sensing chip 3, and both the first predetermined image light source L1 and the second predetermined image light source L2 are processed by the single image signal processor 4 for obtaining a panorama image.

Therefore, the panorama image capturing device D can use the single image sensing chip 3 to capture the first predetermined image light source L1 and the second predetermined image light source L2, and the panorama image capturing device D can use the single image signal processor 4 to process the first predetermined image light source L1 and the second predetermined image light source L2 so as to obtain a panorama image, so that the cost of manufacturing the panorama image capturing device D can be decreased.

### Seventh Embodiment

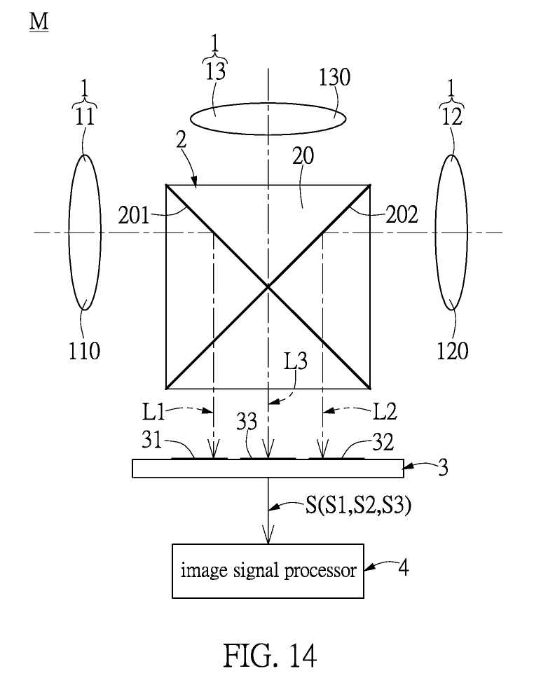

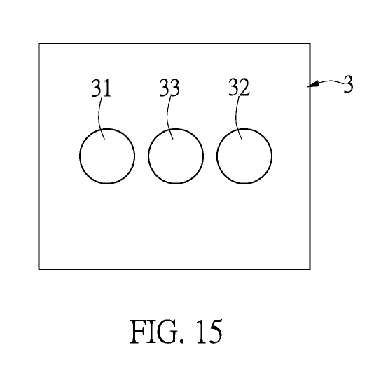

Referring to FIG. 14 to FIG. 15, the seventh embodiment of the present disclosure provides a panorama image capturing module M having at least three camera lenses, including a lens structure 1, an optical structure 2, a single image sensing chip 3, and a single image signal processor 4.

First, referring to FIG. 14 and FIG. 15, the lens structure 1 includes a first lens assembly 11 for capturing a first predetermined image light source L1, a second lens assembly 12 for capturing a second predetermined image light source L2, and a third lens assembly 13 for capturing a third predetermined image light source L3. For example, as shown in FIG. 14, the first lens assembly 11 and the second lens assembly 12 correspond to each other and are respectively disposed beside two opposite sides of the optical structure 2 (that is to say, the first lens assembly 11 and the second lens assembly 12 are not staggered with respect to each other), and the third lens assembly 13 can be disposed above the optical structure 2. In addition, as shown in FIG. 14, the first lens assembly 11 may be composed of one or more first lenses 110, the second lens assembly 12 may be composed of one or more second lenses 120, and the third lens assembly 13 may be composed of one or more third lenses 130. It should be noted that the first lens assembly 11 is composed of the first lens 110, the second lens assembly 12 is composed of the second lenses 120, and the third lens assembly 13 is composed of the third lenses 130 as shown in FIG. 14, but it is merely an example and is not meant to limit the scope of the present disclosure.

Moreover, as shown in FIG. 14, the optical structure 2 is disposed between the first lens assembly 11 and the second lens assembly 12. For example, the optical structure 2 is a light consolidating prism such as an X-prism, the optical structure 2 has a first reflective surface 201 and a second reflective surface 202 which are intersected with each other, and the first reflective surface 201 and the second reflective surface 202 are both disposed inside the light consolidating prism.

Furthermore, referring to FIG. 14 and FIG. 15, the single image sensing chip 3 is adjacent to the optical structure 2, and the single image sensing chip 3 has a first image sensing region 31, a second image sensing region 32 and a third image sensing region 33. More particularly, the first predetermined image light source L1 can be projected onto the first image sensing region 31 through the optical structure 2, the second predetermined image light source L2 can be projected onto the second image sensing region 32 through the optical structure 2, and the third predetermined image light source L3 can be projected onto the third image sensing region 33 through the optical structure 2. That is to say, the single image sensing chip 3 has a first image sensing region 31 for receiving the first predetermined image light source L1 through the optical structure 2, a second image sensing region 32 for receiving the second predetermined image light source L2 through the optical structure 2, and a third image sensing region 33 for receiving the third predetermined image light source L3 through the optical structure 2. In addition, the first predetermined image light source L1 can be captured by the first image sensing region 31 for obtaining a first image signal S1, the second predetermined image light source L2 can be captured by the second image sensing region 32 for obtaining a second image signal S2, and the third predetermined image light source L3 can be captured by the third image sensing region 33 for obtaining a third image signal S3. It should be noted that the first image signal S1, the second image signal S2 and the third image signal S3 can be combined into a single raw image signal S. That is to say, when the first predetermined image light source L1, the second predetermined image light source L2 and the third predetermined image light source L3 are respectively captured by the first image sensing region 31, the second image sensing region 32 and the third image sensing region 33 of the single image sensing chip 3, the single image sensing chip 3 can be used to directly generate a single raw image signal S.

For example, referring to FIG. 14 and FIG. 15, the single raw image signal S can be disposed on a circuit substrate (not shown) and electrically connected to a CMOS chip or any light sensor chip in advance. In addition, the first image sensing region 31 and the second image sensing region 32 correspond to each other, that is to say, the first image sensing region 31 and the second image sensing region 32 are not staggered with respect to each other, and the third image sensing region 33 is disposed between the first image sensing region 31 and the second image sensing region 32. Moreover, the first predetermined image light source L1 can be reflected by the first reflective surface 201 of the optical structure 2 and then is projected onto the first image sensing region 31, the second predetermined image light source L2 can be reflected by the second reflective surface 202 of the optical structure 2 and then is projected onto the second image sensing region 32, and third predetermined image light source L3 can pass through the optical structure 2 and then is projected onto the third image sensing region 33.

It should be noted that the area of the first image sensing region 31, the area of the second image sensing region 32 and the area of the third image sensing region 33 are substantially the same or different. For example, when the area of the first image sensing region 31 is greater than the area of the second image sensing region 32, the first image sensing region 31 can be used as a main image sensing area, and the second image sensing region 32 can be used as an auxiliary image sensing area. When the area of the second image sensing region 32 is greater than the area of the third image sensing region 33, the second image sensing region 32 can be used as a main image sensing area, and the third image sensing region 33 can be used as an auxiliary image sensing area.

It should be noted that any two of the image resolution of the first image sensing region 31, the image resolution of the second image sensing region 32 and the image resolution of the third image sensing region 33 are substantially the same or different. For example, when the image resolution of the first image sensing region 31 is greater than the image resolution of the second image sensing region 32, the first image sensing region 31 can be used as a main image sensing area, and the second image sensing region 32 can be used as an auxiliary image sensing area. When the image resolution of the second image sensing region 32 is greater than the image resolution of the third image sensing region 33, the second image sensing region 32 can be used as a main image sensing area, and the third image sensing region 33 can be used as an auxiliary image sensing area.

In addition, as shown in FIG. 14, the single image signal processor 4 is electrically connected to the single image sensing chip 3. More particularly, the single raw image signal S that includes the first image signal S1, the second image signal S2 and the third image signal S3 can be transmitted to the single image signal processor 4, and then the single raw image signal S that includes the first image signal S1, the second image signal S2 and the third image signal S3 can be processed by the single image signal processor 4 for obtaining a panorama image. That is to say, all of the first predetermined image light source L1, the second predetermined image light source L2 and the third predetermined image light source L3 can be processed by the single image signal processor 4 for obtaining a panorama image. It should be noted that the panorama image can be replaced by a panorama video, and the panorama may be a broad panorama, a 360° panorama, or a spherical panorama.

It should be noted that the first lens assembly 11 and the second lens assembly 12 correspond to each other, the first reflective surface 201 and the second reflective surface 202 of the optical structure 2 correspond to each other, and the first image sensing region 31 and the second image sensing region 32 correspond to each other, so that an optical path of the first predetermined image light source L1 and an optical path of the second predetermined image light source L2 correspond to each other, that is to say, the optical path of the first predetermined image light source L1 and the optical path of the second predetermined image light source L2 are not staggered with respect to each other.

Therefore, the panorama image capturing module M can use the single image sensing chip 3 to capture the first predetermined image light source L1, the second predetermined image light source L2 and the third predetermined image light source L3, and the panorama image capturing module M can use the single image signal processor 4 to process the first predetermined image light source L1, the second predetermined image light source L2 and the third predetermined image light source L3 so as to obtain a panorama image, so that the manufacturing cost of the panorama image capturing module M can be decreased.

### Eighth Embodiment

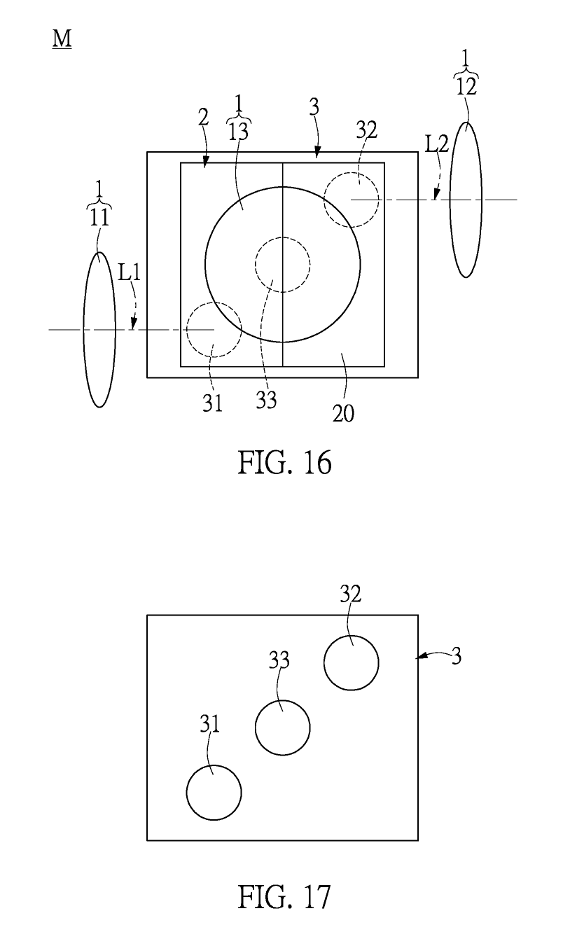

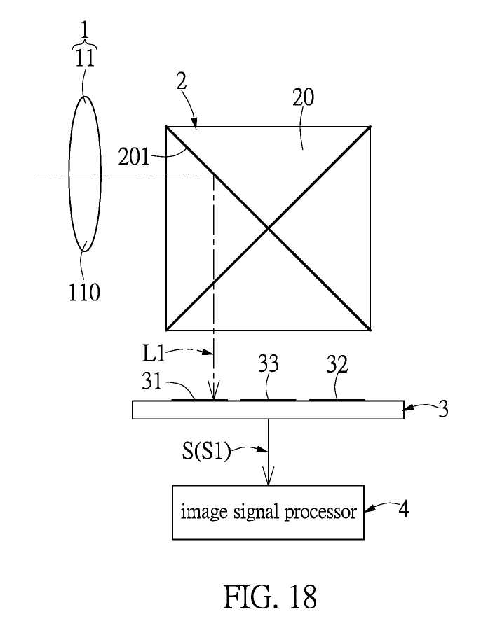

Referring to FIG. 16 to FIG. 7, the eighth embodiment of the present disclosure provides a panorama image capturing module M having at least three camera lenses, including a lens structure 1, an optical structure 2, a single image sensing chip 3, and a single image signal processor 4. Comparing FIG. 16 (and FIG. 18 to FIG. 20) with FIG. 14, and comparing FIG. 17 with FIG. 15, the difference between the eighth embodiment and the seventh embodiment is as follows: in the eighth embodiment, the first lens assembly 11, the second lens assembly 12 and the third lens assembly 13 are staggered with respect to each other relative to a horizontal baseline (not shown) as shown in FIG. 16. In addition, the optical structure 2 has a first reflective surface 201 and a second reflective surface 202 which are intersected with each other, and the first image sensing region 31, the second image sensing region 32 and the third image sensing region 33 are staggered with respect to each other as shown in FIG. 16. Hence, an optical path of the first predetermined image light source L1, an optical path of the second predetermined image light source L2 and an optical path of the third predetermined image light source L3 are staggered with respect to each other.

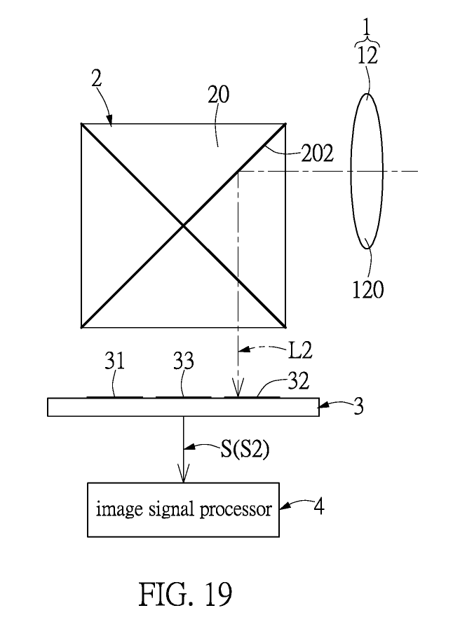

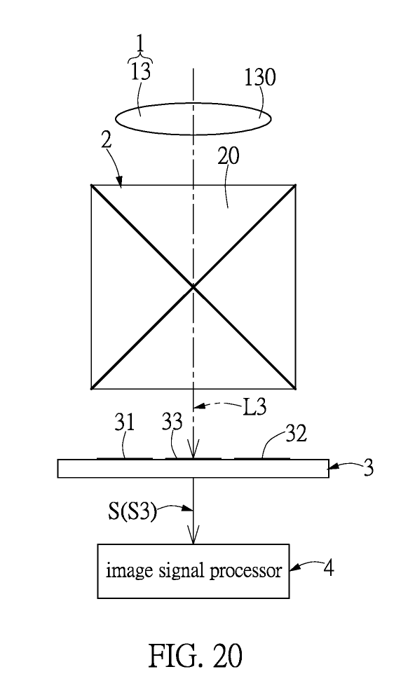

Therefore, referring to FIG. 16 and FIG. 18, the first predetermined image light source L1 can be reflected by the first reflective surface 201 of the optical structure 2 and then is projected onto the first image sensing region 31, and the first predetermined image light source L1 can be captured by the first image sensing region 31 for obtaining a first image signal S1. In addition, referring to FIG. 16 and FIG. 19, the second predetermined image light source L2 can be reflected by the second reflective surface 202 of the optical structure 2 and then is projected onto the second image sensing region 32, and the second predetermined image light source L2 can be captured by the second image sensing region 32 for obtaining a second image signal S2. Then, referring to FIG. 16 and FIG. 20, the third predetermined image light source L3 can pass through the optical structure 2 and then is projected onto the third image sensing region 33, and the third predetermined image light source L3 can be captured by the third image sensing region 33 for obtaining a third image signal S3. Next, the first image signal S1, the second image signal S2 and the third image signal S3 can be combined into a single raw image signal S. Finally, the single raw image signal S that includes the first image signal S1, the second image signal S2 and the third image signal S3 can be transmitted to the single image signal processor 4, and then the single raw image signal S that includes the first image signal S1, the second image signal S2 and the third image signal S3 can be processed by the single image signal processor 4 for obtaining a panorama image.

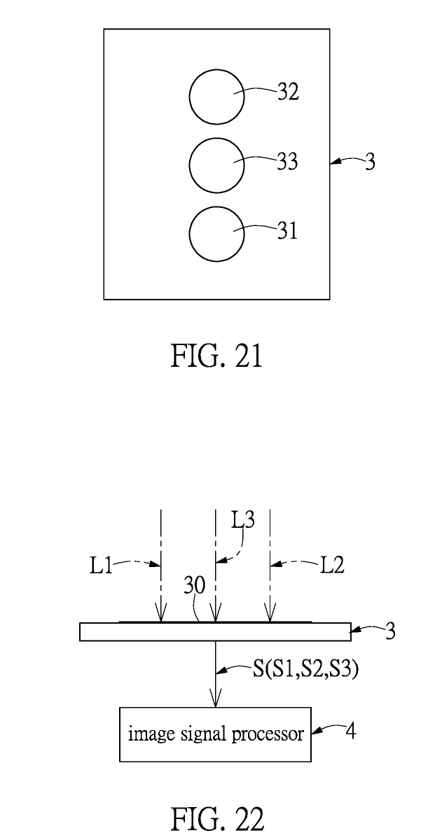

It should be noted that the first image sensing region 31, the second image sensing region 32 and the third image sensing region 33 can also be staggered with respect to each other relative to a horizontal baseline (not shown) as shown in FIG. 21. That is to say, the staggered arrangement of the first image sensing region 31, the second image sensing region 32 and the third image sensing region 33 can be changed according to different requirements. For example, the first image sensing region 31, the second image sensing region 32 and the third image sensing region 33 can be staggered with respect to each other along two different directions such as an X direction and a Y direction (as shown in FIG. 17), or along the same direction such as an X direction or a Y direction (as shown in FIG. 21).

### Ninth Embodiment

Referring to FIG. 22, the ninth embodiment of the present disclosure provides a single image sensing chip 3 and a single image signal processor 4, and the single image sensing chip 3 has a single image sensing region 30. That is to say, the first image sensing region 31, the second image sensing region 32 and the third image sensing region 33 of any one of the seventh and the eighth embodiments can be connected with each other to form a single image sensing region 30.

Therefore, the single image sensing chip 3 can be used by matching the first image sensing region 31, the second image sensing region 32 and the third image sensing region 33 (as shown in the seventh and the eighth embodiments), or can be used by only using the single image sensing region 30 (as shown in the ninth embodiment).

### Tenth Embodiment

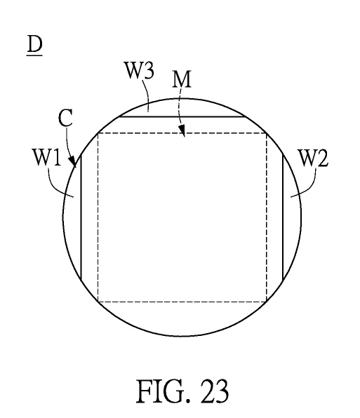

Referring to FIG. 23, the tenth embodiment of the present disclosure provides a panorama image capturing device D having at least three camera lenses, including an outer casing C and a panorama image capturing module M. The panorama image capturing device D as shown in FIG. 23 can use the panorama image capturing module M of any one of the seventh and the eighth embodiments.

For example, referring to FIG. 14 to FIG. 23, the panorama image capturing device D as shown in FIG. 23 can use the panorama image capturing module M of the seventh embodiment. More particularly, the outer casing C has a first light-transmitting window W1 (such as a first transparent cover), a second light-transmitting window W2 (such as a second transparent cover) and a third light-transmitting window W3 (such as a third transparent cover). The panorama image capturing module M is disposed inside the outer casing C, and the panorama image capturing module M includes a lens structure 1, an optical structure 2, a single image sensing chip 3, and a single image signal processor 4.

As described above, the lens structure 1 includes a first lens assembly 11 for capturing a first predetermined image light source L1 through the first light-transmitting window W1, a second lens assembly 12 for capturing a second predetermined image light source L2 through the second light-transmitting window W2, and a third lens assembly 13 for capturing a third predetermined image light source L3 through the third light-transmitting window W3. That is to say, the first lens assembly 11 can be used to capture a first predetermined image light source L1 by a first predetermined wide-angle through the first light-transmitting window W1, the second lens assembly 12 can be used to capture a second predetermined image light source L2 by a second predetermined wide-angle through the second light-transmitting window W2, and the third lens assembly 13 can be used to capture a third predetermined image light source L3 by a third predetermined wide-angle through the third light-transmitting window W3.

As described above, the optical structure 2 is disposed between the first lens assembly 11, the second lens assembly 12 and the third lens assembly 13. In addition, the single image sensing chip 3 is adjacent to the optical structure 2, and the single image sensing chip 3 has a first image sensing region 31 for receiving the first predetermined image light source L1 through the optical structure 2, a second image sensing region 32 for receiving the second predetermined image light source L2 through the optical structure 2, and a third image sensing region 33 for receiving the third predetermined image light source L3 through the optical structure 2. Moreover, the single image signal processor 4 is electrically connected to the single image sensing chip 3, and all of the first predetermined image light source L1, the second predetermined image light source L2 and the third predetermined image light source L3 are processed by the single image signal processor 4 for obtaining a panorama image.

Therefore, the panorama image capturing device D can use the single image sensing chip 3 to capture the first predetermined image light source L1, the second predetermined image light source L2 and the third predetermined image light source L3, and the panorama image capturing device D can use the single image signal processor 4 to process the first predetermined image light source L1, the second predetermined image light source L2 and the third predetermined image light source L3 so as to obtain a panorama image, so that the manufacturing cost of the panorama image capturing device D can be decreased.

In conclusion of the first embodiment to the sixth embodiment, both the first predetermined image light source L1 and the second predetermined image light source L2 can be processed by the single image signal processor 4 for obtaining a panorama image by matching the features of “the single image sensing chip 3 having a first image sensing region 31 for receiving the first predetermined image light source L1 through the optical structure 2, and a second image sensing region 32 for receiving the second predetermined image light source L2 through the optical structure 2” and “the single image signal processor 4 being electrically connected to the single image sensing chip 3”.

That is to say, the panorama image capturing device D or the panorama image capturing module M can use the single image sensing chip 3 to capture the first predetermined image light source L1 and the second predetermined image light source L2, and the panorama image capturing device D or the panorama image capturing module M can use the single image signal processor 4 to process the first predetermined image light source L1 and the second predetermined image light source L2 so as to obtain a panorama image, so that the cost of manufacturing the panorama image capturing device D or the panorama image capturing module M can be decreased.

In conclusion of the seventh embodiment to the tenth embodiment, all of the first predetermined image light source L1, the second predetermined image light source L2 and the third predetermined image light source L3 can be processed by the single image signal processor 4 for obtaining a panorama image by matching the features of “the single image sensing chip 3 having a first image sensing region 31 for receiving the first predetermined image light source L1 through the optical structure 2, a second image sensing region 32 for receiving the second predetermined image light source L2 through the optical structure 2, and a third image sensing region 33 for receiving the third predetermined image light source L3 through the optical structure 2” and “the single image signal processor 4 being electrically connected to the single image sensing chip 3”.

That is to say, the panorama image capturing device D or the panorama image capturing module M can use the single image sensing chip 3 to capture the first predetermined image light source L1, the second predetermined image light source L2 and the third predetermined image light source L3, and the panorama image capturing device D or the panorama image capturing module M can use the single image signal processor 4 to process the first predetermined image light source L1, the second predetermined image light source L2 and the third predetermined image light source L3 so as to obtain a panorama image, so that the manufacturing cost of the panorama image capturing device D or the manufacturing cost of the panorama image capturing module M can be decreased.

The aforementioned descriptions merely represent the preferred embodiments of the present disclosure, without any intention to limit the scope of the present disclosure which is fully described only within the following claims. Various equivalent changes, alterations or modifications based on the claims of the present disclosure are all, consequently, viewed as being embraced by the scope of the present disclosure.

What is claimed is:

1. A panorama image capturing module having at least two camera lenses, comprising:
a lens structure including a first lens assembly for capturing a first predetermined image light source, and a second lens assembly for capturing a second predetermined image light source;
an optical structure disposed between the first lens assembly and the second lens assembly;
a single image sensing chip adjacent to the optical structure, wherein the single image sensing chip has a first image sensing region and a second image sensing region; and
a single image signal processor electrically connected to the single image sensing chip;
wherein the first predetermined image light source is projected onto the first image sensing region through the optical structure, and the first predetermined image light source is captured by the first image sensing region for obtaining a first image signal;
wherein the second predetermined image light source is projected onto the second image sensing region through the optical structure, and the second predetermined image light source is captured by the second image sensing region for obtaining a second image signal;
wherein the first image signal and the second image signal are combined into a single raw image signal;
wherein the single raw image signal is transmitted to the single image signal processor, and the single raw image signal is processed by the single image signal processor for obtaining a panorama image.

2. The panorama image capturing module of claim 1, wherein the first lens assembly and the second lens assembly correspond to each other, the optical structure has a first reflective surface and a second reflective surface corresponding to each other, and the first image sensing region and the second image sensing region correspond to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source correspond to each other.

3. The panorama image capturing module of claim 1, wherein the first lens assembly and the second lens assembly correspond to each other, the optical structure has a first reflective surface and a second reflective surface staggered with respect to each other, and the first image sensing region and the second image sensing region are staggered with respect to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source are staggered with respect to each other.

4. The panorama image capturing module of claim 1, wherein the first lens assembly is composed of one or more first lenses, and the second lens assembly is composed of one or more second lenses, wherein the optical structure has a first reflective surface and a second reflective surface, and the optical structure is one of a prism, a reflective mirror assembly and a light consolidating prism, when the optical structure is the prism, both the first reflective surface and the second reflective surface are disposed inside the prism, wherein when the optical structure is the reflective mirror assembly, both the first reflective surface and the second reflective surface are respectively disposed on an outer surface of a first reflective mirror and an outer surface of a second reflective mirror of the reflective mirror assembly, wherein when the optical structure is a light consolidating prism, the first reflective surface and the second reflective surface are both disposed inside the light consolidating prism, wherein the area of the first image sensing region and the area of the second image sensing region are the same or different, and the image resolution of the first image sensing region and the image resolution of the second image sensing region are the same or different, wherein the first image sensing region and the second image sensing region are connected with each other to form a single image sensing region.

5. A panorama image capturing module having at least two camera lenses, comprising:
a lens structure including a first lens assembly for capturing a first predetermined image light source, and a second lens assembly for capturing a second predetermined image light source;
an optical structure disposed between the first lens assembly and the second lens assembly;
a single image sensing chip adjacent to the optical structure, wherein the single image sensing chip has a first image sensing region for receiving the first predetermined image light source through the optical structure, and a second image sensing region for receiving the second predetermined image light source through the optical structure; and
a single image signal processor electrically connected to the single image sensing chip, wherein both the first predetermined image light source and the second predetermined image light source are processed by the single image signal processor for obtaining a panorama image.

6. The panorama image capturing module of claim 5, wherein the first lens assembly and the second lens assembly correspond to each other, the optical structure has a first reflective surface and a second reflective surface corresponding to each other, and the first image sensing region and the second image sensing region correspond to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source correspond to each other.

7. The panorama image capturing module of claim 5, wherein the first lens assembly and the second lens assembly correspond to each other, the optical structure has a first reflective surface and a second reflective surface staggered with respect to each other, and the first image sensing region and the second image sensing region are staggered with respect to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source are staggered with respect to each other.

8. A panorama image capturing device having at least two camera lenses, comprising:
an outer casing having a first light-transmitting window and a second light-transmitting window; and
a panorama image capturing module disposed inside the outer casing, wherein the panorama image capturing module comprises:
a lens structure including a first lens assembly for capturing a first predetermined image light source through the first light-transmitting window, and a second lens assembly for capturing a second predetermined image light source through the second light-transmitting window;
an optical structure disposed between the first lens assembly and the second lens assembly;
a single image sensing chip adjacent to the optical structure, wherein the single image sensing chip has a first image sensing region for receiving the first predetermined image light source through the optical structure, and a second image sensing region for receiving the second predetermined image light source through the optical structure; and
a single image signal processor electrically connected to the single image sensing chip, wherein both the first predetermined image light source and the second predetermined image light source are processed by the single image signal processor for obtaining a panorama image.

9. The panorama image capturing device of claim 8, wherein the first lens assembly and the second lens assembly correspond to each other, the optical structure has a first reflective surface and a second reflective surface corresponding to each other, and the first image sensing region and the second image sensing region correspond to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source correspond to each other.

10. The panorama image capturing device of claim 8, wherein the first lens assembly and the second lens assembly correspond to each other, the optical structure has a first reflective surface and a second reflective surface staggered with respect to each other, and the first image sensing region and the second image sensing region are staggered with respect to each other, wherein the first predetermined image light source is reflected by the first reflective surface and then is projected onto the first image sensing region, the second predetermined image light source is reflected by the second reflective surface and then is projected onto the second image sensing region, and an optical path of the first predetermined image light source and an optical path of the second predetermined image light source are staggered with respect to each other.
